(19) United States
(12) Patent Application Publication
(10) Pub. No.: US 2011/0158182 A1
(43) Pub. Date: Jun. 30, 2011

(54) METHOD AND SYSTEM OF PACKET SCHEDULING

(75) Inventors: Erez BITON, Herzlia (IL); Moshe Yuda, Rishon-LeZion (IL)

(73) Assignee: Alvarion Ltd., Tel-Aviv (IL)

(21) Appl. No.: 12/647,018

(22) Filed: Dec. 24, 2009

(51) Int. Cl. H04W 72/04

(52) U.S. Cl. 370/329

(57) ABSTRACT

A method of operating a communication system having a plurality of data channels for downlink transmission from a base station to a plurality of subscriber stations. The method comprises receiving, at a base station, an inflow having a plurality of packets of a plurality of connections, each the connection being with one of a plurality of subscriber stations, regulating the inflow according to a throughput rate, setting a deadline to each the packet in the regulated inflow as a function of its reception time, and scheduling a transmission of the plurality of packets to the plurality of subscriber stations according to their deadlines so as to guarantee substantially the throughput rate for each one of the plurality of connections.

### FIELD AND BACKGROUND OF THE INVENTION

The present invention, in some embodiments thereof, relates to method and system of packet scheduling and, more particularly, but not exclusively, to method and system of packet scheduling in wireless networks, such as worldwide interoperability for microwave access (WiMAX) networks.

One of the common wireless architectures is point-to-multipoint (PMP). This architecture consists of a base station (BS) that serves subscriber stations (SSs) in its range. There is usually no communication between the SSs which communicate through the BS. The BS is concerned with the setting up and management of the connections when a SS sends a request. The BS acts as a network gateway.

It should be noted that WiMAX is a connection oriented network.

According to today's WiMAX protocols, WiMAX supports two types of scheduling: downlink scheduling and uplink request/grant scheduling. The downlink scheduling in the BS determines the burst profile and the transmission period for each connection for downlink traffic based on the QoS profile as well as channel/queuing relating criteria.

There is also a downlink scheduler at the SS for classifying the incoming packets into its sub-connections. The uplink request/grant scheduling is performed by the BS with the intent of providing each subordinate SS with bandwidth for uplink transmission or opportunities to request bandwidth.

Being defined by Orthogonal Frequency Division Multiple Access (OFDMA), a WiMAX scheduling slot is defined as a two-dimensional vector including both frequency (sub-channel) axis and time axis, see IEEE 802.16-2004, “IEEE standard for Local and Metropolitan Area Networks—Part 16: Air Interface for Fixed Broadband Wireless Access Systems,” October 2004, which is incorporated herein by reference. Downlink map (DL-MAP) message in the OFDMA frame header is used to indicate the control information of current frames, e.g. the allocation of subchannel and slot.

During the last years, a number of methods have been developed to improve the scheduling schemes of PMP architecture. For example, patent application 2009/10193484, published on Jul. 30, 2009 describes an adaptive scheduling process which dynamically decides which frames need to be transmitted and which need to be dropped at any transmission opportunity based on current channel conditions and on characteristics of each frame.

Another example is described in U.S. Pat. No. 7,392,014 which describes a communication system comprises a downlink data channel for the transmission of data packets from a primary station to a secondary station and uplink and downlink control channels. The secondary station measures one or more characteristics of the data channel and issues a report to the primary station, which determines an operational parameter of the data channel in response to the report. The secondary station determines average channel characteristics over a measurement period. The length of the measurement period may be signaled by the primary station or determined directly by the secondary station. In one embodiment the selected period depends on the speed of the secondary station. This is determined by either station and tested to determine whether it is outside the range for the current measurement period: if it is the period is reset.

### SUMMARY OF THE INVENTION

According to some embodiments of the present invention, there is provided a method of operating a communication system having a plurality of channels for downlink transmission from a base station to a plurality of subscriber stations. The method comprises receiving an inflow having a plurality of packets of a plurality of connections, each the connection being with one of a plurality of subscriber stations, regulating the inflow according to a throughput rate, setting a deadline to each the packet in the regulated inflow as a function of its reception time, and scheduling a transmission of the plurality of packets to the plurality of subscriber stations according to their deadlines so as to guarantee substantially the throughput rate for each one of the connections.

Optionally, the receiving is performed at a base station.

Optionally, the receiving is performed at a subscriber station.

Optionally, the plurality of connections are plurality of non real time (NRT) connections.

More optionally, the receiving comprises receiving a plurality of packets of the NRT connections and of real time (RT) connections, the scheduling being performed so as to guarantee substantially the throughput rate for each one of the RT and NRT connections.

More optionally, the scheduling comprises scheduling the NRT and RT connections as a single group of RT connections.

More optionally, the setting comprises setting a deadline to each the packet of the plurality of NRT connections in the regulated inflow as a function of its reception time and the throughput rate.

Optionally, the regulating is performed according to a plurality of token released in about the throughput rate by a token bucket mechanism.

Optionally, the scheduling is performed by processing the deadlines according to a deadline scheduling discipline.

Optionally, the scheduling comprises queuing the plurality of packets in a plurality of scheduling packet queues.

Optionally, the transmission is performed over at least one of Long Term Evolution (LTE) channels and worldwide interoperability for microwave access (WiMAX)™ channels.

Optionally, the reception time is at least one of a head of line arrival time and a tail of line arrival time.

According to some embodiments of the present invention, there is provided a communication system having a plurality of data channels for downlink transmission from a base station to a plurality of subscriber stations. The system comprises an input interface which receives an inflow having a plurality of packets of plurality of connections, each the connection being with one of a plurality of subscriber stations, a regulating module which regulates the inflow according to a throughput rate, a computing unit which computes a deadline to each the packet in the regulated inflow as a function of its reception time and the throughput rate, and a scheduler which schedules a transmission of the plurality of packets to the plurality of subscriber stations according to their deadlines so as to guarantee substantially the throughput rate for each one of the plurality of connections.

Optionally, the plurality of connections are plurality of non real time (NRT) connections.

Optionally, the inflow having a plurality of packets of the plurality of NRT connections and a plurality of real time (RT) connections, the scheduler schedules the transmission so as to guarantee substantially the throughput rate for each one of the plurality of NRT and RT connections.

Optionally, the computing unit which computes a deadline to each the packet of the plurality of NRT connections in the regulated inflow as a function of its reception time and the throughput rate.

Optionally, the computing unit computes a deadline to each the packet of the plurality of NRT connections in the regulated inflow as a function of its reception time and the throughput rate.

Optionally, the regulating module comprises by a token bucket mechanism that regulates the inflow by releasing a plurality of token in about the throughput rate.

Optionally, the scheduler schedules the transmission according to a deadline scheduling discipline.

According to some embodiments of the present invention, there is provided a computer program product, comprising at least one computer usable medium having a computer readable program code embodied therein, the computer readable program code adapted to be executed to implement a method of operating a communication system. The method comprises receiving an inflow having a plurality of packets of a plurality of connections, each the connection being with one of a plurality of subscriber stations, regulating the inflow according to a throughput rate, setting a deadline to each the packet in the regulated inflow as a function of its reception time, and scheduling a transmission of the plurality of packets to the plurality of subscriber stations according to their deadlines so as to guarantee substantially the throughput rate for each one of the plurality of connections.

Optionally, the plurality of connections are plurality of non real time (NRT) connections.

More optionally, the receiving comprises receiving an inflow having a plurality of packets of the plurality of NRT connections and a plurality of real time (RT) connections, the scheduling comprises scheduling the transmission so as to guarantee substantially the throughput rate for each one of the plurality of NRT and RT connections.

Optionally, the setting comprises setting a deadline to each the packet of the plurality of NRT connections in the regulated inflow as a function of its reception time and the throughput rate.

Optionally, the receiving is performed at a base station.

Optionally, the receiving is performed at a subscriber station.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic block diagram a radio communication system that comprises a primary station and a plurality of secondary stations, according to some embodiments of the present invention; and

FIG. 2 is a flowchart of a method of scheduling a transmission of packets over a plurality of wireless network channels in a point-to-multipoint architecture, according to some embodiments of the present invention.

### DESCRIPTION OF EMBODIMENTS OF THE INVENTION

The present invention, in some embodiments thereof, relates to method and system of packet scheduling and, more particularly, but not exclusively, to method and system of packet scheduling in wireless networks, such as worldwide interoperability for microwave access (WiMAX) networks.

According to some embodiments of the present invention, there are provided methods and systems for scheduling packets of non real time connections, optionally in combination with real time connections, so as to guarantee a certain throughput rate and/or burst. In these embodiments, which are implemented at a primary station, such as a base station of a WiMAX™ network, each packet, which may belong to a non real time connection, is assigned with a deadline upon reception and/or upon arrival to the tail and/or the head of line which may be referred to herein as reception. The deadlines are set to assure that when all packets of the NRT connection are transmitted before their respective deadlines, the NRT connection is served with a guaranteed rate. Consequently, the NRT connection, or a group of NRT connections, may be scheduled according to the assigned deadlines and be provided with the guaranteed rate. Optionally, these deadline values are as high as possible, to allow opportunistic scheduling,

Optionally, the base station regulates the received inflow of packets, for example by using a token bucket mechanism, according to the guaranteed rate. The regulation assures that the ingress packets meet their incoming rate bounds.

Optionally, the scheduling is performed by processing the deadlines according to an earliest deadline first (EDF) scheduling discipline or an opportunistic version thereof.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The invention details the scheduling performed at a base station. It should be understood, however, that same methods are applicable for scheduling at a subscriber station. An example of a need to do so is in systems which allocate transmission opportunities to subscriber stations, but it is up to the subscriber station to decide which of the packets, belonging potentially to several traffic flows, are to be included in each transmission.

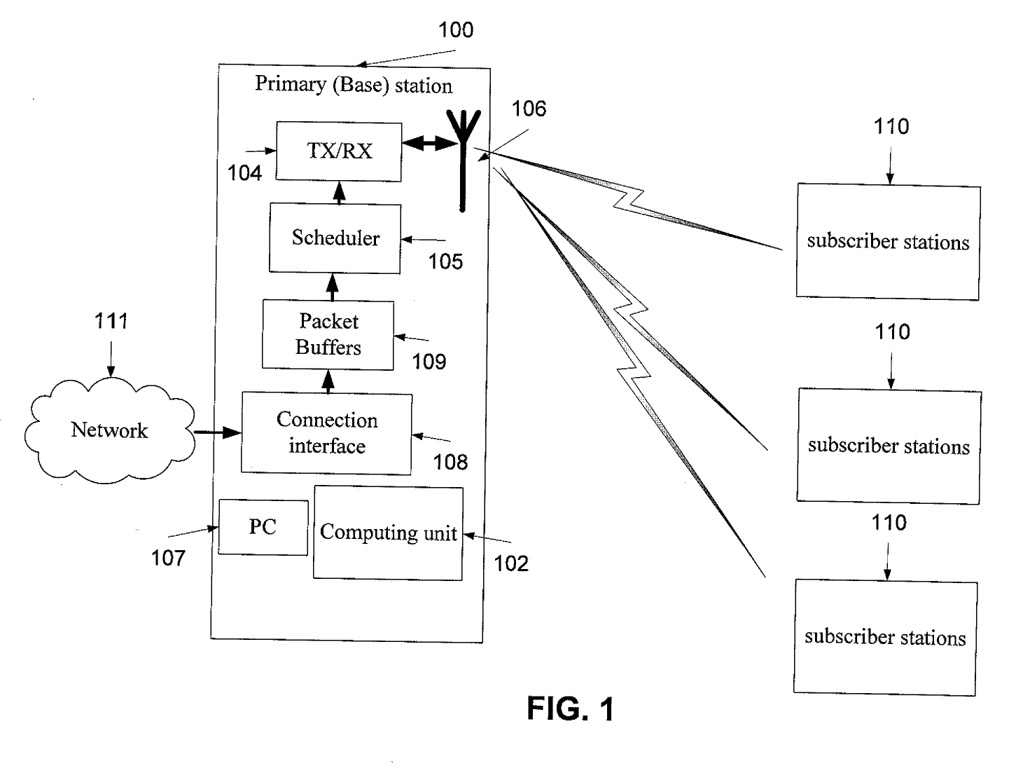

Reference is now made to FIG. 1, which is a schematic block diagram a radio communication system that comprises a primary station, such as a base station (BS) 100 and a plurality of secondary stations, such as subscriber stations (SS) 110, according to some embodiments of the present invention. The BS 100 comprises a computing unit 102, such as a microcontroller, transceiver means (Tx/Rx) 104 connected to antenna means 106, power control means (PC) 107 for altering the transmitted power level, and connection interface 108 for connecting the BS 100 to a communication network 111, such as a local area network (LAN) and a wide area network (WAN), for example via a public switched telephone network (PSTN) switch, a cable infrastructure switch, and/or any other suitable network. Communication from the BS 100 to each SS 110 takes place on a downlink channel. The BS further comprises a scheduler 105, such as a BS medium access control (MAC) scheduler, and one or more packet buffers 109. It should be mentioned that though the description herein mostly describes processes and systems for scheduling downlink channels, such as WiMAX™ channels as defined in 802.16e and 802.16m protocols which are incorporated herein by reference and LTE downlink channels, similar mechanisms and methodologies may be used for scheduling uplink channels.

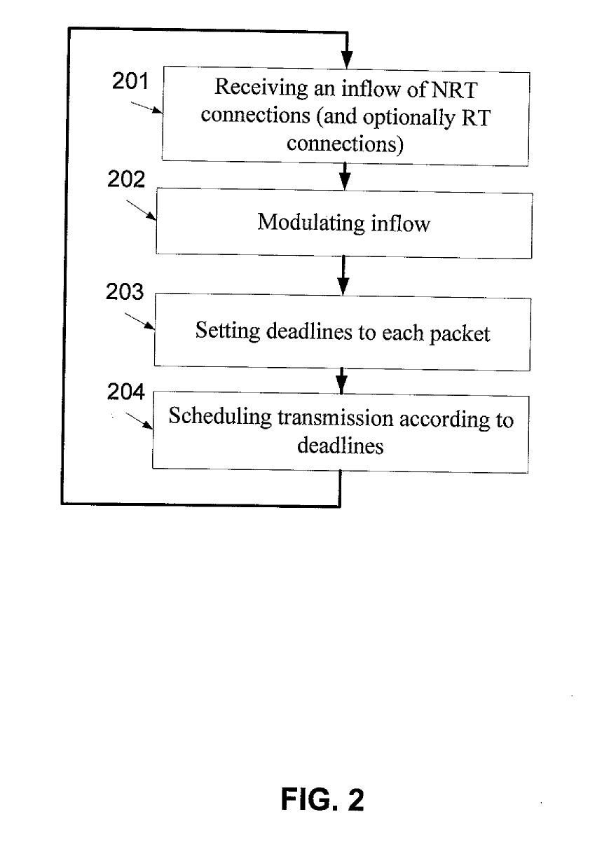

Reference is also made to FIG. 2, which is a flowchart of a method of scheduling a transmission of packets over a plurality of wireless network channels in a point-to-multipoint (PMP) architecture, according to some embodiments of the present invention. The scheduling is optionally downlink (DL) scheduling that is implemented by a WiMAX BS.

The method is optionally implemented by the BS 100 in order to schedule the transmission of non real-time connections (NRT), and optionally packets of real-time (RT) connections, with the SSs 110, referred to herein as NRT connections and optionally RT connections. The connections include MAC connections that can be established with quality of services (QoS) specified by AuthorizedQoSParamSet and the Service Level Prediction, as defined in IEEE Standard 802.16M™(draft)—2009, 802.16™—2009, 802.16e™-2005 and/or IEEE Std 802.16™-2004/Cor1-2005, which are incorporated herein by reference. For brevity, any connection with a guaranteed delay, for example a Guaranteed Bit Rate (GBR) connection, may be referred to herein as a RT connection and any connection with a non guaranteed delay, for example a non-Guaranteed Bit Rate (NBR). Connection, may be referred to herein as an NRT connection.

As shown at 201, the base station 100 receives an inflow of packets from the communication network 111. The packets are related to plurality of NRT connections, and optionally RT connections, with the SSs 110.

Now, as shown at 202, the inflow of packets of the NRT connections, and optionally RT connections, is regulated according to a certain throughput rate and/or burst, for brevity referred to herein as a throughput rate. It should be noted that the throughput rate may be determined at the establishment of the connections, for example according to parameters assigned by the operator.

The regulated inflow is forwarded to an input buffer. The throughput rate is optionally defined as the maximum value which ensures the input buffer is not overloaded. Optionally, a regulation module, such as a token bucket mechanism is used for regulating the throughput rate of the inflow. In such an embodiment, tokens are inserted into a token buffer at a rate ρ that is optionally equal to the throughput rate that is guaranteed for the transmitted NRT connections and optionally the RT connections. Packets which arrive when the token buffer is empty are dropped, stored in a designated buffer and/or forwarded to another transmission system. An example for such a packet inflow is an inflow of packets which are sent at a higher rate and/or burst than the agreed. Optionally, the token bucket mechanism takes into account the size of each packet. In such an embodiment, each predefined number of bits or bytes, for example 1, 2, 4, and 8 receives a token. For example, when a packet of n bytes arrives and each token equals a single byte, n tokens are removed from the token buffer and the packet is sent to the input buffer, which may be referred to as a packet queue. In such a manner, the token bucket regulates and/or shapes the rate and/or burst of the inflow into the input buffer to be not higher than ρ. The regulation of the inflow assures that the input queue is not overload as the queue at the output of a token bucket cannot be overloaded.

In some embodiments of the present invention, the scheduler 105 manages a plurality of scheduling packet queues, each for a different connection or a channel with a possibly different SS 110. In such an embodiment, packets which are outputted from the token bucket mechanism, and not filtered out due to the regulation, are sent into the respective scheduling packet queue. Optionally, different packets have different sizes. In such an embodiment, packets are sent only if there are at least b tokens in bucket, so that b·token.size≧packet.size. Optionally, each scheduling packet queue is associated with a scheduling service that represents a data handling mechanism supported by the scheduler 105 for data transport on a connection to one of the SSs 110. Each connection is associated with a single data scheduling service.

Now, as shown at 203, a deadline is set to each packet as a function of at least its reception time and/or arrival to the tail and/or head of line time and the throughput rate that is regulated by the system 100. In such embodiments, the deadline is indicative of the expiration time of the packet that is based on the throughput of the input queue as the deadline to each packet equals to the maximum value that ensures the input queue is not overloaded.

For brevity, a packet tagged with a deadline may be referred to herein as a deadline tagged packet.

Optionally, the deadlines are set according to token bucket state, packet queue length, packet size and/or the guaranteed rate. The assignment of a deadline in such a manner guarantees that if all packets of the NRT connections and optionally the RT connections are transmitted before their respective deadlines, the related SSs, which are addressed by these connections, are served with a guaranteed rate, for example the throughput rate that is regulated as described above.

In use, a deadline is associated with each packet to allow the scheduling of the packets according to an order, a priority queue, which is based on their deadlines. In each scheduling event the priority queue is searched for a packet having the closest deadline to the actual time. This packet is scheduled for transmission in the next packet transmission interval.

According to some embodiments of the present invention, packets of the RT connections are defined with deadlines according to one or more QoS parameters which are related thereto and packets of NRT connections are defined with deadlines according to a certain throughput rate, for example as described above or suggested below. In such embodiments, the scheduling of the RT and NRT packets may be performed together, though the deadlines have been set differently.

Optionally, some or all of the deadlines of the NRT packets are defined, per unit, as follows:

$$deadline ( {P}_{i}^{t} ) = t + \frac{{Q}_{i} - L ( {P}_{i}^{t} ) - {σ}_{i} ( t )}{{ρ}_{i}} \qquad Equation 1$$

where, Pᵢ^{t} denotes a packet designated to the i^{th} scheduling packet queue that is associated with the NRT connection at arrival time t that denotes arrival time of Pᵢ^{t}, Qᵢ denotes α max size in bytes in the i^{th} scheduling packet queue, σᵢ denotes a current size, in bytes, of a group of tokens inside of connection i which is awaiting for transmission at the scheduler, L(Pᵢ^{t}) denotes the size, in bytes, of Pᵢ^{t}, and ρᵢ denotes the rate in which the token bucket is filled. This is the rate which the connection should be satisfied with.

As described above, scheduling packet queues may be used for storing the packets from the regulated inflow. In such an embodiment, each deadline tagged packet is forwarded to one of the queues according its designated SSs and/or ID tag.

Now, as shown at 204, the scheduler 105 schedules the transmission of each one of the deadline tagged packets according its deadline. The assignment of deadlines, as described above, enables scheduling RT and NRT connections as a single group of RT connections.

In this stage, after the assignment of deadlines, each packet, or each head of line (HoL) packet of an NRT connection, holds a deadline, which enables referring to all the NRT connections as RT connections at a certain throughput rate.

Optionally, a head of line (HoL) packet may be scheduled according to the following equation:

$${j}^{*} = {arg}_{i} max \{ \frac{{R}_{i} ( t )}{Avg\_Rate} * \frac{{W}_{i} ( t )}{{d}_{i} ( t )} \} , \qquad Equation 2$$

where t denotes a time instance for which the scheduling decision is made, for example the time of the relevant frame.

Rᵢ(t) denotes an instantaneous channel data rate for the i^{th} SS based on channel state information, such as the reported channel quality indicator (CQI) of the respective channel and/or the available power;

Wi(t) denotes a delay experienced by the HoL packet as an outcome of the sorting thereof into the i^{th} scheduling packet queue; and

di(t) denotes the time to expire of the i^{th} packet deadline.

Such scheduling assures obtaining high total throughput while providing the throughput rate of all the RT and NRT connections is not lower than the input throughput rate that is regulated, for example by the token bucket mechanism. In such a manner, a committed information rate (CiR) may be guaranteed to both RT and NRT connections through the provision of delay. Moreover, in such a manner, the packets of RT and NRT connections are scheduled according to a common scheduling mechanism, such as the scheduler 105 of FIG. 1. As only a single module is used for scheduling the RT and NRT connections there is not need to interface between the modules which separately schedule RT connections and NRT connections. In addition, the scheduling of all the packets may be done according to EDF so that there is not need to integrate a Weighted fair queuing (WFQ) scheduling. Using a single module, such as an EDF scheduler, and not 2 modules, one of them may be a similar EDF scheduler, simplifies the maintenance of the system and reduces error and/or malfunction rate.

It should be noted that the computational complexity of scheduling NRT and RT connections as a single group of RT connections, is more efficient than scheduling the RT connections and NRT connections apart. A common scheduling usually adopts WFQ for scheduling NRT connections and EDF for scheduling RT connections. When WFQ is used, after a connection (NRT connection) is selected for transmitting, the priorities of all the NRT connections of the BS as to be updated, a process with computational complexity of O_{(N)}. When EDF is used, after selecting an RT connection for transmitting, we only need to update its place inside the heap of the RT connections, a process with computational complexity of O_{(logN)}. Thus, scheduling RT and NRT connections as RT connections, for example by using EDF, is more computational efficient than using EDF for RT connections, and WFQ for NRT connections.

As shown at 205, this process is iteratively repeated as long as NRT connections and optionally the RT connections are established with the SSs 110.

It is expected that during the life of a patent maturing from this application many relevant systems and methods will be developed and the scope of the term network, scheduler, computing unit, and Rx/Tx is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of operating a communication system having a plurality of channels for downlink transmission from a base station to a plurality of subscriber stations, comprising:
receiving an inflow having a plurality of packets of a plurality of connections, each said connection being with one of a plurality of subscriber stations;
regulating said inflow according to a throughput rate;
setting a deadline to each said packet in said regulated inflow as a function of its reception time; and
scheduling a transmission of said plurality of packets to said plurality of subscriber stations according to their deadlines so as to guarantee substantially said throughput rate for each one of said connections.

2. The method of claim 1, wherein said receiving is performed at a base station.

3. The method of claim 1, wherein said receiving is performed at a subscriber station.

4. The method of claim 1, wherein said plurality of connections are plurality of non real time (NRT) connections.

5. The method of claim 4, wherein said receiving comprises receiving a plurality of packets of said NRT connections and of real time (RT) connections, said scheduling being performed so as to guarantee substantially said throughput rate for each one of said RT and NRT connections.

6. The method of claim 5, wherein said scheduling comprises scheduling said NRT and RT connections as a single group of RT connections.

7. The method of claim 4, wherein said setting comprises setting a deadline to each said packet of said plurality of NRT connections in said regulated inflow as a function of its reception time and said throughput rate.

8. The method of claim 1, wherein said regulating is performed according to a plurality of token released in about said throughput rate by a token bucket mechanism.

9. The method of claim 1, wherein said scheduling is performed by processing said deadlines according to a deadline scheduling discipline.

10. The method of claim 1, wherein said scheduling comprises queuing said plurality of packets in a plurality of scheduling packet queues.

11. The method of claim 1, wherein said transmission is performed over at least one of Long Term Evolution (LTE) channels and worldwide interoperability for microwave access (WiMAX)™ channels.

12. The method of claim 1, wherein said reception time is at least one of a head of line arrival time and a tail of line arrival time.

13. A communication system having a plurality of data channels for downlink transmission from a base station to a plurality of subscriber stations, comprising:
an input interface which receives an inflow having a plurality of packets of plurality of connections, each said connection being with one of a plurality of subscriber stations;
a regulating module which regulates said inflow according to a throughput rate;
a computing unit which computes a deadline to each said packet in said regulated inflow as a function of its reception time and said throughput rate; and
a scheduler which schedules a transmission of said plurality of packets to said plurality of subscriber stations according to their deadlines so as to guarantee substantially said throughput rate for each one of said plurality of connections.

14. The communication system of claim 13, wherein said plurality of connections are plurality of non real time (NRT) connections.

15. The communication system of claim 14, wherein said inflow having a plurality of packets of said plurality of NRT connections and a plurality of real time (RT) connections, said scheduler schedules said transmission so as to guarantee substantially said throughput rate for each one of said plurality of NRT and RT connections.

16. The communication system of claim 14, wherein said computing unit which computes a deadline to each said packet of said plurality of NRT connections in said regulated inflow as a function of its reception time and said throughput rate.

17. The communication system of claim 14, wherein said computing unit computes a deadline to each said packet of said plurality of NRT connections in said regulated inflow as a function of its reception time and said throughput rate.

18. The communication system of claim 13, wherein said regulating module comprises by a token bucket mechanism that regulates said inflow by releasing a plurality of token in about said throughput rate.

19. The communication system of claim 13, wherein said scheduler schedules said transmission according to a deadline scheduling discipline.

20. A computer program product, comprising at least one computer usable medium having a computer readable program code embodied therein, said computer readable program code adapted to be executed to implement a method of operating a communication system, comprising:
receiving an inflow having a plurality of packets of a plurality of connections, each said connection being with one of a plurality of subscriber stations;
regulating said inflow according to a throughput rate;
setting a deadline to each said packet in said regulated inflow as a function of its reception time; and
scheduling a transmission of said plurality of packets to said plurality of subscriber stations according to their deadlines so as to guarantee substantially said throughput rate for each one of said plurality of connections.

21. The computer program product of claim 20, wherein said plurality of connections are plurality of non real time (NRT) connections.

22. The computer program product of claim 21, wherein said receiving comprises receiving an inflow having a plurality of packets of said plurality of NRT connections and a plurality of real time (RT) connections, said scheduling comprises scheduling said transmission so as to guarantee substantially said throughput rate for each one of said plurality of NRT and RT connections.

23. The computer program product of claim 21, wherein said setting comprises setting a deadline to each said packet of said plurality of NRT connections in said regulated inflow as a function of its reception time and said throughput rate.

24. The computer program product of claim 21, wherein said receiving is performed at a base station.

25. The computer program product of claim 21, wherein said receiving is performed at a subscriber station.
